(19) United States
(12) Patent Application Publication
(10) Pub. No.: US 2008/0020781 A1
(43) Pub. Date: Jan. 24, 2008

(54) Apparatus And Method For Tracking The Position Of A Person/Object Using A Mobile Communication Network

(75) Inventor: Choon Geun Cho, Seoul (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: ULTRASTARCOM KOREA LIMITED, Gyeonggi-do (KR)

(21) Appl. No.: 10/567,529

(22) PCT Filed: Sep. 24, 2004
(86) PCT No.: PCT/KR04/02466

§ 371 Date: Mar. 19, 2007

(30) Foreign Application Priority Data
Sep. 26, 2003 (KR) 10-2003-0066875

(51) Int. Cl. H04Q 7/22

(52) U.S. Cl. 455/456.1

(57) ABSTRACT

The present invention relates to an apparatus for tracking a position using a mobile communication network comprising terminals, a base station transmission system (BTS), a base station controller (BSC), a mobile switching center (MSC), a Home Location Register (HLR), a Short Message Service (SMS) and a position information management server. More particularly, the position tracking apparatus comprises: a CDMA wireless transmission and reception element for performing basic CDMA wireless transmissions and receptions; a position information extracting element for receiving position information from a GPS satellite; an emergency call button for performing PUSH actions when a user lies in the emergency; a memory for storing emergency messages and external notification voice data; a Radio Frequency Identification (RFID) processing element for providing personal information of the user; a controller for performing current position notifications or output of the external notification voice data upon receiving instructions from the position information management server, and performing low-power position registrations in the HLR by determining low-power position registrations based on the distance/time using a distance/time based timer; and a speaker for outputting the external notification voice data. Hence, the present invention allows the user to manage the emergency more simply and rapidly when the user is in an emergency, and allows the production of scale-down and low-power terminals to be realized.

### TECHNICAL FIELD

The present invention generally relates to an apparatus and method for tracking the position of a person/object using a Code Division Multiple Access (CDMA) technology, and more particularly to an apparatus and method for tracking the position of the person/object using a mobile communication network.

### BACKGROUND ART

As is well known, a mobile communication system comprises: mobile communication terminals that can be carried by users; base station transmission systems (BTSs) established in individual regions; a plurality of base station controllers (BSCs) for controlling the BTSs; and a mobile switching center (MSC) for performing various switching operations in connection with the plurality of BSCs. This mobile communication network has been already established all over the nation. Therefore, the user can engage in wireless telephone calls if he or she moves into an area where a wire telephone network is not established.

As a result of constant improvement in the mobile communication service, there have been developed various services such as wireless telephone calls, short message switching services using a short message service (SMS), internet information providing services, and position tracking services for tracing the position of a mobile communication terminal and warning a guardian of the user's emergency, etc.

Thus, the user carrying the mobile communication terminal can rapidly inform the guardian, a hospital staff, or an emergency center such as 911 of an urgent situation through various mobile communication services even when he does not have access to any wire telephone.

Korean Utility Model Registration No. 0164185, Korean Laid-open Patent Publication No. 2002-0004534, and Korean Laid-open Patent Publication No. 2003-0022613 disclose certain conventional position tracking apparatuses that use the mobile communication network.

More specifically, the mobile communication terminal according to Korean Utility Model Registration No. 0164185 comprises: a small signal transmission device for periodically transmitting a CDMA signal to the mobile communication network, and (2) a mobile communication means for detecting position information and emergency call information by receiving the signal.

However, the mobile communication terminal according to Korean Utility Model Registration No. 0164185 is problematic in that the user cannot cope with the emergency through the above-described mobile communication terminal if he or she is unable to operate the terminal (e.g., a baby, a pet and a troubled old man cannot perform the complex operation of the conventional mobile communication terminal). As such, nobody around the user would know the emergency situation of the user if the user does not operate his or her terminal. Further, it is not possible to acquire accurate position information of the user since the position information can be extracted only by each of the BTSs.

Moreover, Korean Laid-open Patent Publication No. 2002-0004534 discloses a method for providing the current position information of the object to the users. It further discloses a recording medium for recording the position information. The Korean Laid-open Patent Publication No. 2003-0022613 teaches a method for providing the position information to the user by using a Global Positioning System (GPS) through the Internet, and preventing a child from being lost by notifying his or her guardian that the child departed from the guardian's protected area.

However, the mobile communication terminal according to Korean Laid-open Patent Publication No. 2002-0004534 and Korean Laid-open Patent Publication No. 2003-0022613 has problems in that when an emergency situation (e.g., missing, illness of user or theft of object with the terminal) occurs, there is no way to inform the people around the terminal about these emergences. It is not suitable for protecting a baby, a pet or others unable to perform the complex operation of the terminal because it is difficult to find their accurate positions. An additional wireless communication system is required to provide the position information service. This causes significant costs to be incurred for the additional functions and/or modifications.

In particular, the mobile communication terminal according to Korean Utility Model Registration No. 0164185, Korean Laid-open Patent Publication No. 2002-0004534, and Korean Laid-open Patent Publication No. 2003-0022613 has problems in that there is an increase in power consumption for registration in case frequent position registrations are needed (e.g., in case of high speed movement). This is because a signal is periodically (i.e., unconditionally) transmitted to perform the position registration of the terminal to the mobile communication network. Furthermore, at the terminals disclosed in the above-described publications are deficient in that additional devices, such as keypad and screen display, must be provided and hence power consumption increases for the position registrations. Thus, it is not possible to downsize the battery and the terminal.

### DISCLOSURE OF INVENTION

### Technical Problem

Thus, the present invention is provided in order to solve the problems described above. The purpose of the invention is to provide an apparatus and method for tracking the position of a person/object using the mobile communication network to rapidly and accurately inform the guardian through a simple operation of pressing a button when a child carrying the terminal is in an emergency.

One purpose of the invention is to provide an apparatus and method for tracking the position of a person/object by using the mobile communication network to audibly project out an emergency alarm to people around the terminal under the guardian's control from a remote position when a baby, a pet or an old man is in an emergency condition.

Another purpose of the invention is to provide an apparatus and method for tracking the position of a person/object using the mobile communication network while minimizing the power consumption of the terminal by performing the position registration using a short message service in case of transmitting information between the terminal and the mobile communication network. Further, the purpose of the invention is to provide an improved method of registering the position of the terminal in consideration of both the distance and time.

Yet another purpose of the invention is to provide an apparatus and method for tracking the position of a person/object using the mobile communication network while downsizing the terminal by eliminating the keypad and screen display. This allows the user to conveniently carry the terminal and further reduces the price of the terminal.

Still yet another purpose of the invention is to provide an apparatus and method for tracking the position of a person/object using the mobile communication network to manage the sudden sickness of the user or an urgent crime circumstance by rapidly providing a Radio Frequency Identification (RFID) within the terminal and providing certain information, such as personal information and clinical history of the user.

### Technical Solution

In order to achieve the above objects/purposes, there is provided an apparatus for tracking the position of a person/object by using a mobile communication network comprising a plurality of terminals, a base station, a control station, a switching center, a Home Location Register (HLR), a Short Message Service (SMS) server and a position information management server. The apparatus comprises: a CDMA wireless transmission and reception element for performing basic CDMA wireless transmissions and receptions in the mobile communication network; a position information extracting element for receiving position information from a GPS satellite and outputting the position information; an emergency call button for outputting an emergency call selection signal when a user performs a PUSH action in case of an emergency; a memory for storing an emergency message and an external notification audio data; a Radio Frequency Identification (RFID) processing element for providing personal information; and a controller.

The controller performs the following actions: producing a current position by using the position information extracting element upon receiving a position information call instruction and transmitting the position information to the position information management server; reading the external notification audio data stored in the memory upon receiving an external notification instruction from the position information management server through a short message service and outputting the same; reading an emergency message stored in the memory when the emergency call selection signal has been inputted from the emergency call button and transmitting the same together with the current position information of the user to the position information management server through the short message service; and performing position registration in the HLR by determining position registration using an embedded distance/time standard timer, and a speaker for receiving the external notification audio data including the current emergency of the user and its measures from the controller and audibly projecting out the same.

Further, there is provided a method for tracking the position of a person/object by using a mobile communication network comprising a plurality of terminals, a base station, a control station, a switching center, a HLR, a SMS server and a position information management server. The method comprises: a step (100) for the terminal to perform position registration and authentication process to the HLR via the mobile communication network in case it is powered on; a step (200) for the terminal to have a time and distance standard timer initialized, to produce current position, and to be inverted into sleep mode; a step (300) for the terminal to determine whether an instruction is input from a position information management server or a user; a step (400) for the terminal to determine whether position registration is performed by using a time and distance standard position registration/determination method for lowering power consumption in case the instruction is not input from the position information management server or the user at step 300, and to perform position registration to the HLR in case it is determined to be performed; a step (500) for the terminal to be converted into active mode in case the instruction is input from the position information management server or the user at step 300, and to determine what is the instruction; and a step (600) for the terminal to notify the position information management server of current position information via the SMS in case the instruction is a request for position information received from the position information management server, then to proceed to step 200, and to be inverted into sleep mode.

Further, there is provided an apparatus for tracking the position of a person/object by using a mobile communication network comprising a plurality of terminals, a base station, a control station, a switching center, a HLR, a SMS server and a position information management server. The apparatus comprises: a position information processing means for managing position information of a plurality of terminals 100 to transmit a request for position information to corresponding terminal via the SMS upon reception of a request for the user's position information from the protector, and decoding encrypted position information received via the SMS for the protector's reading; and a notification processing means for transmitting a notification request to corresponding terminal via the SMS upon reception of the protector's request.

Further, there is provided a method for tracking the position of a person/object by using a mobile communication network comprising a plurality of terminals, a base station, a control station, a switching center, a HLR, a SMS server and a position information management server. The method comprises: a step (1001) for the position information management server to determine what is an instruction upon reception of the instruction form a protector; a step (1002) for the position information management server to transmit a request for position information to corresponding terminal via the SMS upon reception of a request for emergency notification from the protector at step 1001; and a step (1003) for the position information management server to transmit a request for position information to corresponding terminal via the SMS upon reception of a request for position information of corresponding terminal from the protector at step 1001, and then to decode encrypted position information received via the SMS for the protector's reading.

### BRIEF DESCRIPTION OF THE DRAWINGS

FIG. 1 is a view showing the configuration of a mobile communication network comprising an apparatus for tracking the position of the person/object using the mobile communication network in accordance with an embodiment of the present invention.

FIG. 2 is a functional block diagram showing the detailed configuration of the terminal in the mobile communication network as shown in FIG. 1

FIG. 3 is a functional block diagram showing the detailed configuration of the position information management server in the mobile communication network as shown in FIG. 1

FIG. 4 is a flow chart that illustrates a processing step of the terminal in a method of tracking the position of the person/object using the mobile communication network in accordance with an embodiment of the present invention.

FIG. 5 is a flow chart that illustrates a processing step during a power-off in the processing step of the terminal as shown in FIG. 4.

FIG. 6 is a flow chart that illustrates a detailed processing step of step 400 in the processing step of the terminal as shown in FIG. 4.

FIG. 7 is a flow chart that illustrates a processing step in the position information management server in a method of tracking the position of the person/object using the mobile communication network in accordance with an embodiment of the present invention.

### BEST MODE FOR CARRYING OUT THE INVENTION

Hereinafter, an apparatus and method for tracking the position of a person/objection by using a mobile communication network according to one preferred embodiment of the present invention will be explained in detail.

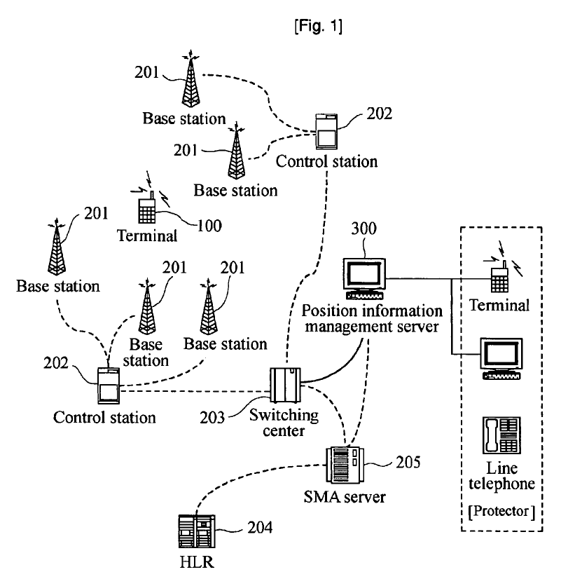

FIG. 1 is a view showing the configuration of a mobile communication network comprising an apparatus for tracking the position of the person/object using the mobile communication network in accordance with an embodiment of the present invention. The apparatus for tracking the position of a person/objection by using a mobile communication network according to one preferred embodiment of the present invention comprises: a plurality of terminals 100; and a mobile communication network 200 including base station 201, control station 202, switching center 203, Home Location Register (HLR) 204, Short Message Service (SMS) server 205, etc.; and position information management server 300. The mobile communication network 200 is in charge of registering and authorizing a location between a plurality of terminals 100 and position information management server 300, and switching a SMS.

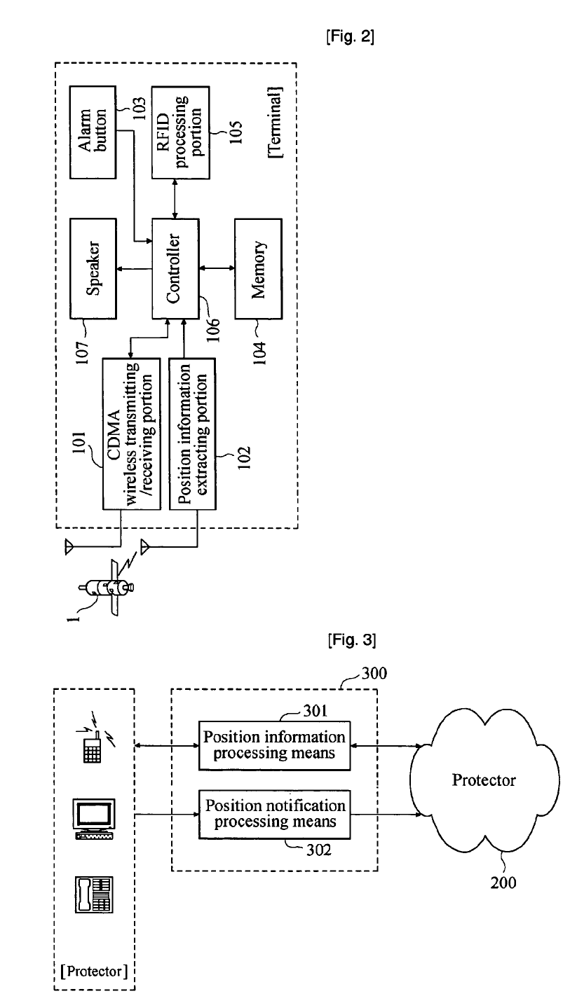

As shown in FIG. 2, a plurality of terminals 100 comprises CDMA wireless transmitting/receiving portion 101, position information extracting portion 102, alarm button 103, memory 104, RFID processing portion 105, controller 106 and speaker 107. It is better to manufacture Terminal 100 as a handheld device (e.g., a watch or a necklace) because it can be downsized.

CDMA wireless transmitting/receiving portion 101 installed in terminal 100 is controlled to perform CDMA wireless communication in mobile communication network 200 by controller 106.

Position information extracting portion 102 instated in terminal 100 receives a plurality of Global Positioning System (GPS) data related to position tracking from GPS satellites 1, and outputs the data to controller 106.

Alarm button 103 instated in terminal 100 is for outputting an emergency call selection signal in case a user of terminal 100 pushes alarm button 103 in an emergency.

Memory 104 instated in terminal 100 stores data for emergency, the user's current emergency, and voice data for audibly projecting out an emergency measure, wherein the data for emergency includes messages for notifying an emergency and a telephone number of the user's protector.

RFID processing portion 105 instated in terminal provides the user's personal information (e.g., clinical history). Thus, an official of a hospital or a 911 crew can more easily obtain the user's personal information.

Controller 106 installed in terminal 100 calculates a current position of the user by using position information extracting portion 102 upon reception of a short message requesting for position information from position information management server 300. It then transmits the cited position information to position information management server 300.

Further, controller 106 receives a request for warning an emergency from position information management server 300 via a SMS, and then reads voice data for emergency notification from memory 104 to audibly project out the voice data. Controller 106 also takes charge of reading emergency messages from memory 104 and transmitting the emergency messages to position information management server 300 together with the terminal's current position information via a SMS.

Furthermore, controller 106 has an embedded time and distance standard timer to register its position at HLR 204 by using a time and distance standard position registration/determination method for lowering power consumption.

Speaker 107 installed in terminal 100 receives from controller 106 voice data for emergency notification containing the user's current emergency and an emergency measure, and audibly projects the same out.

Position information management server 300 is connected with the protector having a certain terminal via a wire/wireless phone, an internet or other interfaces. It comprises position information processing means 301 and notification processing means 302 as shown in FIG. 3.

Position information processing means 301 instated in position information management server 300 manages position information of a plurality of terminals 100 to transmit a request for position information to corresponding terminal 100 via a SMS upon reception of a request for the users position information from the protector. In addition, position information processing means 301 decodes encrypted position information received via a SMS for the protector's reading.

Notification processing means 302 installed in position information management server 300 transmits a notification request to corresponding terminal 100 via a SMS upon reception of the protector's request.

With reference to the accompanying drawings, there will be explained a method for tracking the position of a person/object by using a mobile communication network according to the above preferred embodiment of the present invention.

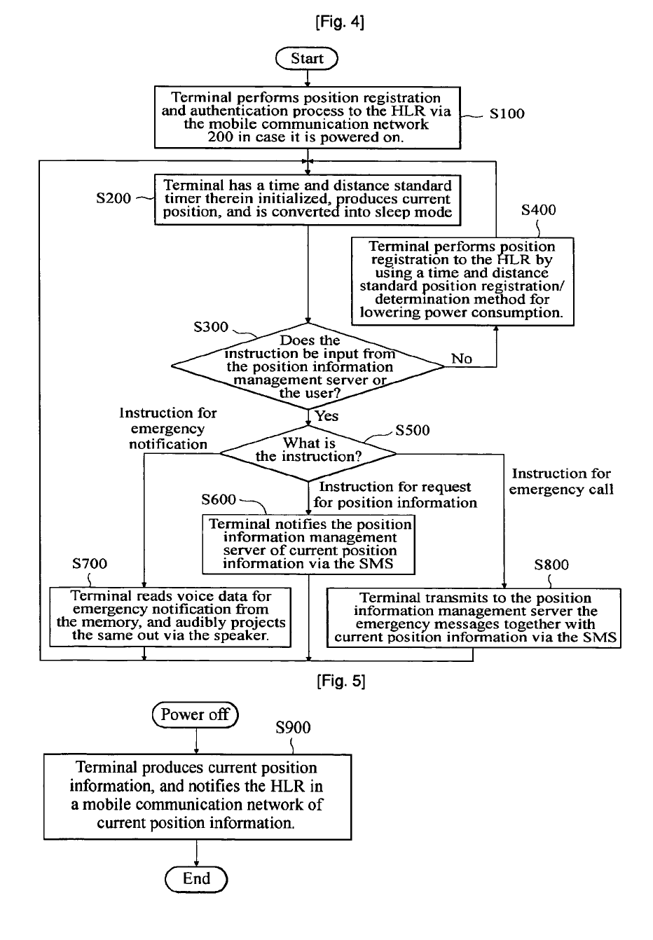

First, with reference to FIG. 4, there will be explained a processing step of the terminal in a method of tracking the position of the person/object using the mobile communication network in accordance with an embodiment of the present invention.

Controller 106 of the terminal 100 performs position registration and authentication process to the HLR via the mobile communication network 200 in case it is powered on (S100).

Then, the controller 106 initializes a time and distance standard timer disposed therein, produces current position, and is converted into sleep mode (S200).

Thereafter, the controller 106 determines whether an instruction is input from a position information management server or a user (S300).

In case the instruction is not input from the position information management server or the user at step 300 (S300) (NO), the controller 106 determines whether position registration is performed by using a time and distance standard position registration/determination method for lowering power consumption. It performs position registration to the HLR 204 in case it is determined to be performed (S400).

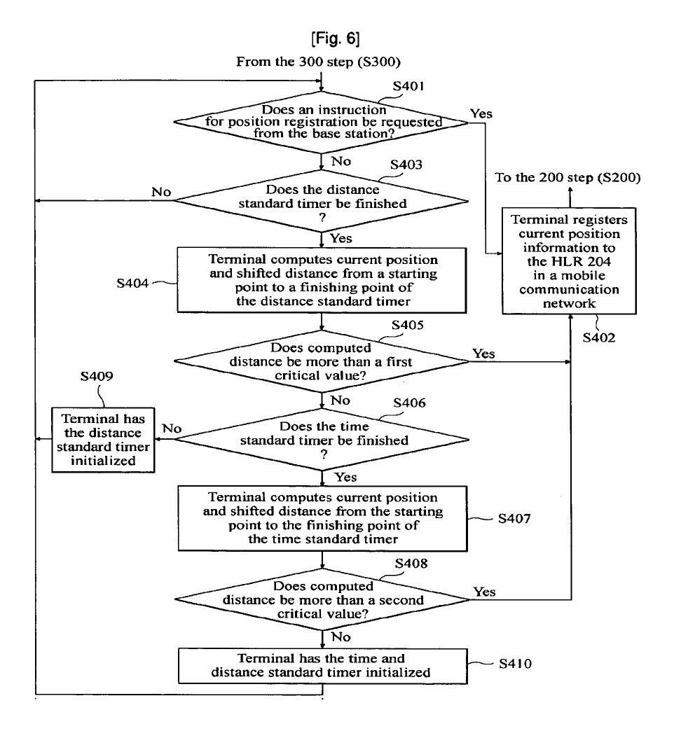

With reference to FIG. 6, a processing step of position registration at the above step 400 (S400) will be explained.

First, the controller 106 determines whether an instruction for position registration is requested from the base station 201 (S401).

In case the instruction for position registration is requested from the base station 201 at step 401 (S401) (YES), the controller 106 registers current position information to the HLR 204, and then proceeds to step 200 (S200) (S402).

On the other hand, in case the instruction for position registration is not requested from the base station 201 at step 401 (S401) (NO), the controller 106 determines whether the distance standard timer is finished (S403).

In case the distance standard timer is not finished at step 403 (S403) (NO), the controller 106 proceeds to step 401 (S401). However, in case the timer is finished at step 403 (YES), the controller 106 computes the current position and shifted distance from a starting point to a finishing point of the distance standard timer (S404).

Then, the controller 106 determines whether shifted distance from the starting point to the finishing point of the distance standard timer is more than a first critical value (S405). Here, the first critical value is set to be more than a distance standard position registration optimum parameter, which is used in a current mobile communication terminal.

In case shifted distance from the starting point to the finishing point of the distance standard timer is more than the first critical value at step 405 (S405) (YES), the controller 106 proceeds to step 402 (S402) and registers current position information. However, in case shifted distance is less than the first critical value (NO), the controller 106 determines whether the time standard timer is finished (S406).

In case the time standard timer is finished at step 406 (S406) (YES), the controller 106 computes current position and shifted distance from the starting point to the finishing point of the time standard timer (S407).

Then, the controller 106 determines whether shifted distance from the starting point to the finishing point of the time standard timer is more than a second critical value (S408). In case shifted distance is more than the second critical value (YES), the controller proceeds to step 402 (S402) and registers current position information. Here, the second critical value is set to be less than a time standard position registration optimum parameter, which is used in a current mobile communication terminal.

Meanwhile, in case the time standard timer is not finished at step 406 (S406) (NO), the controller 106 has the distance standard timer initialized and then proceeds to step 401 (S401) (S409).

Further, in case shifted distance from the starting point to the finishing point of the time standard timer is less than the second critical value at the 408 step (S408) (NO), the controller 106 has the time and distance standard timer initialized and then proceeds to step 401 (S401) (S410).

On the other hand, in case the instruction is input from the position information management server 300 or the user at step 300 (S300) (YES), the controller 106 is converted into active mode and then determines what is the instruction (S500).

In case the instruction is a request for position information received from the position information management server 300 via the SMS at step 500 (S500), the controller notifies the position information management server 300 of current position information via the SMS, then proceeds to step 200 (S200) and is converted into sleep mode (S600).

Meanwhile, in case the instruction is for emergency notification received from the position information management server 300 at step 500 (S500), the controller 106 reads voice data for emergency notification containing the user's current emergency and an emergency measure from the memory 104, and audibly projects out the same via the speaker 107 (S700). Here, the examples of voice data for emergency notification are as follows. If an infant or a pet is lost, then a voice message “I am lost, call the police or 02-123-4567” is projected out. If an object is lost, then a voice message “please return it to an appropriate owner, the number is 02-123-4567” is projected out. These voice data can be repeated and are set so that a user can change them.

On the contrary, in case the instruction is for emergency call input the user at step 500 (S500), the controller 106 reads emergency messages from the memory 104, and transmits the emergency messages to the position information management server 300 together with current position information via the SMS (S800).

As shown in FIG. 5, in case the user tries to power off at any time during steps 100 to 800 (S100-S800), the controller 106 produces current position information, notifies the HLR 204 of current position information, and then finishes the process (S900).

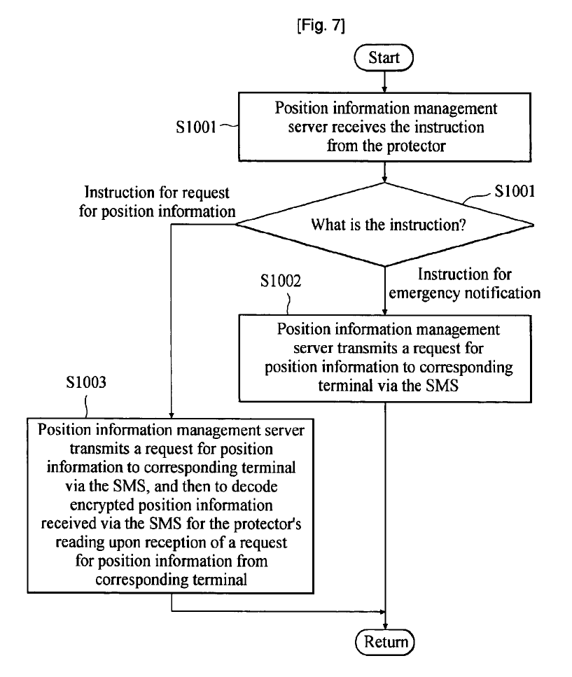

With reference to FIG. 7, there will be explained a processing step of position information management server in a method of tracking the position of the person/object using the mobile communication network in accordance with an embodiment of the present invention.

First, the position information management server 300 determines what is an instruction upon reception of the instruction from a protector (S1001).

The position information management server 300 transmits a request for position information to corresponding terminal via the SMS upon reception of a request for emergency notification from the protector (S1002).

On the other hand, the position information management server 300 transmits a request for position information to corresponding terminal via the SMS 205 upon reception of a request for position information of corresponding terminal 100 from the protector at step 1001 (S1001), and then decodes the encrypted position information received via the SMS for the protector's reading (S1003).

In the above, the present invention is explained in detail with reference to some particular embodiments. However, the invention is not necessarily limited to those embodiments, and could be varied within the scope thereof.

### INDUSTRIAL APPLICABILITY

As explained above, by using an apparatus and method for tracking the position of the person/object using the mobile communication network, it becomes possible to rapidly and accurately inform the guardian of the emergency through a simple operation such as pressing a button when the ward carrying the terminal is in an emergency. It becomes further possible to output the emergency to people around the terminal by the voice under the guardian's controlling at a distance when a subject, such as baby or a pet having no ability to operate the terminal, is in an emergency.

Additionally, it becomes possible to minimize the power consumption of the terminal by performing the position registration using a short message service in case of transmitting information between the terminal and the mobile communication network, and adopting the improved method of registering the position of the terminal in consideration of both the distance and time.

Further, it becomes possible to downsize the size of the terminal by eliminating the keypad and screen display, thus allowing the user to conveniently carry the terminal while reducing the cost of the terminal.

Further, it becomes possible to rapidly manage a sudden sickness of the user or a urgent crime circumstance by providing a Radio Frequency Identification (RFID) within the terminal and providing information such as personal information and sickness history of the user.

1. An apparatus for tracking the position of a person/object by using a mobile communication network comprising a plurality of terminals, a base station, a control station, a switching center, a Home Location Register (HLR), a Short Message Service (SMS) server and a position information management server, the apparatus comprising:
a CDMA wireless transmission and reception element for performing basic CDMA wireless transmissions and receptions in the mobile communication network;
a position information extracting element for receiving position information from a GPS satellite and outputting the position information;
an emergency call button for outputting an emergency call selection signal when a user performs a PUSH action in case of an emergency;
a memory for storing an emergency message and an external notification audio data;
a Radio Frequency Identification (RFID) processing element for providing persona information; and
a controller for performing the following actions:
producing a current position by using the position information extracting element upon receiving a position information call instruction and transmitting the position information to the position information management server;
reading the external notification audio data stored in the memory upon receiving an external notification instruction from the position information management server through a short message service and outputting the same;
reading an emergency message stored in the memory when the emergency call selection signal has been inputted from the emergency call button and transmitting the same together with the current position information of the user to the position information management server through the short message service; and
performing position registration in the HLR by determining position registration using an embedded distance/time standard timer; and
a speaker for receiving the external notification audio data including the current emergency of the user and its measures from the controller and audibly projecting out the same.

2. A method for tracking the position of a person/object by using a mobile communication network comprising a plurality of terminals, a base station, a control station, a switching center, a Home location Register (HLR), a Short Message Service (SMS) server and a position information management server, the method comprising:
a step (100) for the terminal to perform position registration and authentication process to the HLR via the mobile communication network in case it is powered on;
a step (200) for the terminal to have a time and distance standard timer initialized, to produce current position, and to be converted into sleep mode;
a step (300) for the terminal to determine whether an instruction is input from a position information management server or a user;
a step (400) for the terminal to determine whether position registration is performed by using a time and distance standard position registration/determination method for lowering power consumption in case the instruction is not input from the position information management server or the user at step 300, and then to perform position registration to the HLR in case it is determined to be performed;
a step (500) for the terminal to be converted into active mode in case the instruction is input from the position information management server or the user at step 300, and then to determine what is the instruction; and
a step (600) for the terminal to notify the position information management server of current position information via the SMS in case the instruction is a request for position information received from the position information management server, then to proceed to step 200, and to be converted into sleep mode.

3. A method for tracking the position of a person/object according to claim 2, wherein step 400 comprises:
a step (401) for the terminal to determine whether an instruction for position registration is requested from the base station;
a step (402) for the terminal to register current position information to the HLR, and then proceed to step 200 in case the instruction for position registration is requested from the base station at step 401;
a step (403) for the terminal to determine whether the distance standard timer is finished in case the instruction for position registration is not requested from the base station at step 401;
a step (404) for the terminal to proceed to step 401 in case the distance standard timer is not finished at step 403, and to compute current position and shifted distance from a starting point to a finishing point of the distance standard timer to in case the timer is finished at step 403;
a step (405) for the terminal to determine whether shifted distance from the starting point to the finishing point of the distance standard timer is more than a first critical value;
a step (406) for the terminal to proceed to step (402) and to register current position information in case shifted distance from the starting point to the finishing point of the distance standard timer is more than the first critical value at step (405), and to determine whether the time standard timer is finished in case shifted distance is less than the first critical value;
a step (407) for the terminal to compute current position and shifted distance from the starting point to the finishing point of the time standard timer, in case the time standard timer is finished at step 406; and
a step (408) for the terminal to determine whether shifted distance from the starting point to the finishing point of the time standard timer is more than a second critical value, to proceed to step 402 in case shifted distance is more than the second critical value, and to register current position information.

4. A method for tracking the position of a person/object according to claim 3, wherein the method further comprises a step (409) for the terminal to have the distance standard timer initialized, and then to proceed to step 401 in case the time standard timer is not finished at step 406.

5. A method for tracking the position of a person/object according to claim 3, wherein the method further comprises a step (410) for the terminal to have the time and distance standard timer initialized, and then to proceed to step 401 in case shifted distance from the starting point to the finishing point of the time standard timer is less than the second critical value at step 408.

6. A method for tracing the position of a person/object according to claim 3, wherein the method further comprises a step (700) for the terminal to read voice data for emergency notification containing the user's current emergency and an emergency measure from a memory, and to audibly project the same out via a speaker in case the instruction is for emergency notification received from the position information management server.

7. A method for tracking the position of a person/object according to claim 3, wherein the method further comprises a step (800) for the terminal to read emergency messages from a memory, to transmit to the position information management server the emergency messages together with current position information via the SMS, and then to proceed to step 200 in case the instruction is for emergency call input the user at step 500.

8. A method for tracking the position of a person/object according to claim 3, wherein the method further comprises a step (900) for the terminal to produce current position information, to notify the HLR of current position information, and then to finish a process in case the user tries to power off at any time during each of the steps.

9. A method for tracking the position of a person/object according to claim 3, wherein the first critical value is set to be more than a distance standard position registration optimum parameter, the second critical value is set to be less than a time standard position registration optimum parameter, which is used in a current mobile communication terminal respectively.

10. An apparatus for tracking the position of a person/object by using a mobile communication network comprising a plurality of terminals, a base station, a control station, a switching center, a Home Location Register (HLR) a Short Message Service (SMS) server and a position information management server, the apparatus comprising:
a position information processing means for managing position information of a plurality of terminals 100 to transmit a request for position information to corresponding terminal via the SMS upon reception of a request for the user's position information from the protector, and decoding encrypted position information received via the SMS for the protector's reading; and
a notification processing means for transmitting a notification request to corresponding terminal via the SMS upon reception of the protector's request.

11. A method for tracking the position of a person/object by using a mobile communication network comprising a plurality of terminals, a base station, a control station, a switching center, a Home Location Register (HLR), a Short Message Service (SMS server and a position information management server, the method comprising:
a step (1001) for the position information management server to determine what is an instruction upon reception of the instruction form a protector;
a step (1002) for the position information management server to transmit a request for position information to corresponding terminal via the SMS upon reception of a request for emergency notification from the protector at step 1001; and
a step (1003) for the position information management server to transmit a request for position information to corresponding terminal via the SMS upon reception of a request for position information of corresponding terminal from the protector at step 1001, and then to decode encrypted position information received via the SMS for the protector's reading.
